(19) United States
(12) Patent Application Publication
(10) Pub. No.: US 2009/0070146 A1
(43) Pub. Date: Mar. 12, 2009

(54) Method for managing the release of data

(76) Inventors: Sultan Haider, Erlangen (DE); Klaus Abraham-Fuchs, Erlangen (DE); Volker Schmidt, Moehrendorf (DE); David Wolfgang Eberhard Schmidt, Erlangen (DE); Dominic Pascal Schmidt, Erlangen (DE)

Correspondence Address: BRINKS HOFER GILSON & LIONE, P.O. BOX 10395, CHICAGO, IL, 60610, US

(21) Appl. No.: 11/978,807

(22) Filed: Oct. 29, 2007

Related U.S. Application Data
(60) Provisional application No. 60/993,134, filed on Sep. 10, 2007.

(51) Int. Cl. G06Q 50/00

(52) U.S. Cl. 705/3

(57) ABSTRACT

A system and method is described for managing the release of information from a personal electronic health record (EHR). A central data warehouse maintains at least a part of the HER along with at least a copy of a patient's permission plan for the release of data to others in the health care system. Requests for information may be made by addressees, each addressee possessing credentials. The system and method compares the credentials of the addressee with the personal permissions plan and releases the information permitted by the permissions plan. Where information is denied by the plan, the patient may be offered the opportunity to modify profiles of the plan so as to permit the release of information. The patient may be provided with background information on the need for release of the data, and legal aspects of the release of the data so as to make an informed choice.

This application claims the benefit of U.S. Provisional application Ser. No. 60/993,134, filed on Sep. 10, 2007, which is incorporated herein by reference.

### TECHNICAL FIELD

The present application relates generally to the improvement of medical treatment. In particular, aspects of the management of medical data relating to the release of medical information are addressed.

### BACKGROUND

Many people consider information about their health to be highly sensitive, deserving of the strongest protection under the law. Long-standing laws in many states and the age-old tradition of doctor-patient privilege have been the mainstay of privacy protection for decades. The extent of privacy protection given to medical information often depends on where the records are located and the purpose for which the information was compiled. The laws that cover privacy of medical information vary by situation.

Medical records may be created when a patient receives treatment from a health professional such as a physician, nurse, dentist, or psychiatrist. Records may include personal medical history, details about the patient's lifestyle (such as smoking or involvement in high-risk sports), and family medical history.

In addition, medical records usually contain laboratory test results, medications prescribed, and reports that indicate the results of operations and other medical procedures, participation in research projects or clinical trials, allergies, adverse drug reactions, and the like. Records could also include the results of genetic testing.

Information provided on applications for disability, life or accidental insurance with private insurers or government programs may also become part of a medical file.

Certain medical information may be releasable to insurance companies or government agencies for the purpose of verifying claims for reimbursement. However, the release of medical information may be under the control of the patient. In the United States, regulations implementing the law on medical privacy, in accordance with the Health Insurance Portability and Accountability Act of 1996 (HIPAA), went into effect Apr. 14, 2003 and establish standards for patient privacy including the right of patients to access to their own records. There may be existing state laws and regulations that provide additional protections for this information.

The privacy rules issued under HIPAA generally treat all health information the same and allows health care providers to disclose protected health information without the individual's express permission for treatment, payment and health-care operations. Thus, under the HIPAA Privacy Rule, even “sensitive” health information may be disclosed to others for treatment, payment and health care operations without the individual's express permission. However, most states have statutes or regulations that afford a higher degree of protection to information related to certain health conditions and treatment. These laws often require the individual's written permission in order to disclose this “sensitive” health information, sometimes even for treatment purposes.

With the progress in information technology, it has becomes possible to make medical, administrative, payment-relevant, and other data of an individual patient accessible centrally; the data itself may be located in different hospital information data bases, doctors' office information, health insurance, and other information systems. Access to these data is increasingly regulated by the patient himself; the patient releases for treatment facilities either in the form of excerpts or complete sets.

The patient usually does not have a clear understanding of which data the physician needs to treat a specific problem and can not therefore intelligently consent to release data. Apart from privacy issues, the alternative of simply releasing all the data leads to increased expense from the standpoint of a service provider, when the relevant data must be searched for in a very large quantity of data and transmitted over a network.

By various names, countries around the world are developing electronic health record (EHR) systems, which may include electronic health cards of various forms. The patient may become the “master” of his/her own data; and access to the data can be had only by using a chip card (for instance, an electronic health card), or more than one chip card (such as the electronic health card and health care professional identification).

### BRIEF SUMMARY

A system for controlling the release of medical-related information is described, the system including a central data warehouse, having at least a data base of personal permissions plans, and an interface to a telecommunications network. Requests for data received through the interface and the credentials of an addressee may be compared against one of the personal permissions plans, and data authorized by the personal permissions plan may be transmitted thought the interface to the addressee. The central data warehouse maintains a data base of personal medical records comprising at least a portion of a personal electronic health record (EHR) for a person, and a data base of personal permission plans, each personal permission plan being capable of controlling the release of information from the personal EHR.

In an aspect, a local access device, located at a medical facility communicates with the central by transmitting data over a telecommunications network and the local access device may be configured to accept credential data.

A method of managing the release of medical data from an electronic health record (EHR) is described, the method including maintaining a personal electronic health record (EHR), at least in part, in a central data warehouse; maintaining at least a copy of a personal permissions plan corresponding to the EHR; receiving requests for data in the EHR, the requests including the credentials of the addressee requesting the data; comparing the credentials of the addressee with the personal permissions plan and determining whether the requested data is releasable to the addressee; and transmitting at least metadata representing the releasable data.

In an aspect, when requested data is not releasable to the addressee, the patient is notified of the request. The patient may be presented with options for managing the requests, including confirming the refusal of the requests, or modifying the permissions plan so as to permit the requests.

### BRIEF DESCRIPTION OF THE DRAWINGS

FIG. 1 illustrates a system for maintaining and controlling the release of information in an electronic health record (EHR);

FIG. 2 illustrates a central data warehouse in the system of FIG. 1;

FIG. 3 illustrates the relationships of profiles in a permissions plan for the release of medical records;

FIG. 4 illustrates another group of relationships between profiles;

FIG. 5 shows steps in a method of controlling the release of information form an EHR;

FIG. 6 illustrates a step in the method of FIG. 5 for maintaining profiles in a permissions plan; and

FIG. 7 illustrates a detail of the step of FIG. 6.

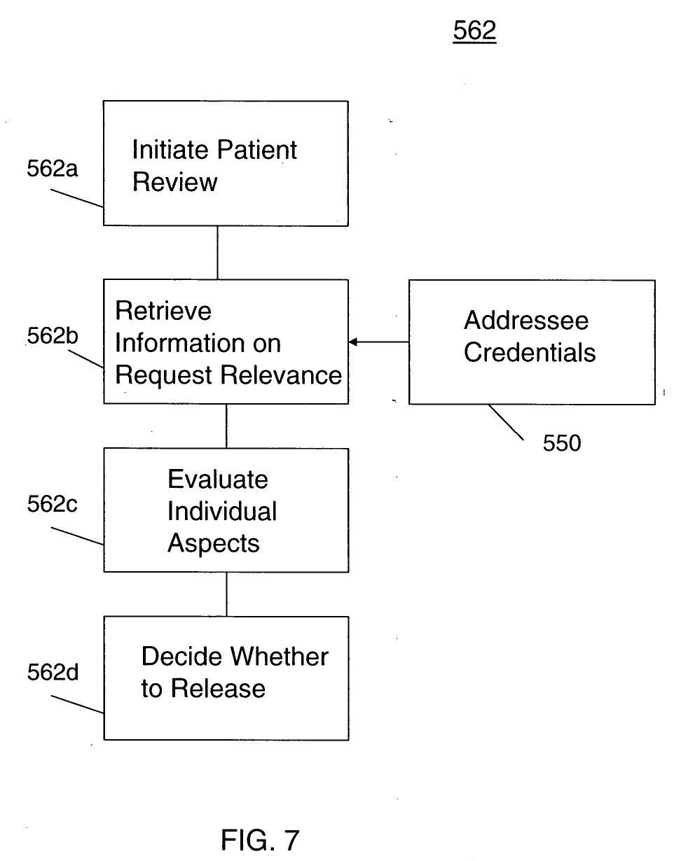

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may be stored in a remote location for transfer through a computer network, a local or wide area network, or over telephone lines. In yet other embodiments, the instructions are stored within a given computer or system. The instructions may be a computer program product, stored or distributed on computer readable media, containing some or all of the instructions to be executed on a computer to perform all or a portion of the method or the operation of the system.

The embodiments described herein include methods, processes, apparatuses, computer program instructions, systems, or business concepts for generating a personal medical data release permissions plan, for using the plan in managing the release of medical records, and for assisting the patient to configure the permissions plan to take account of medical information requirements for treatment and to be consistent with a patient's personal privacy concerns and rights.

A “medical facility” as used herein is considered to encompass any location, whether temporary or permanent, where medical treatment may be performed or managed. This includes, but is not limited to hospitals, clinics, nursing facilities, physicians offices, emergency response vehicles, insurance providers, and the like, where access to the data is permitted.

An “addressee” or “user” as used herein is considered to encompass medical personnel of all types and functions, including administrative personnel. The level of access to the data of an individual care plan may be limited depending on the function of the user and the relationship of the user to the patient.

A “permissions plan” is a personal instrument that expresses the individual patient's decisions as to the availability of medical records to other persons, known here as “addressees” or “users” which may be individuals, organizations, or functional groups; the permissions plan may differ, in different political jurisdictions, based on the laws, regulations and customs of the place.

The permissions plan may include personal profiles or sub-profiles that are stored in a memory. The memory may be on a “smart card” or other carrier that is in the possession of the patient, or in a computer data base, which the patient or a representative of the patient may access. The computer data base may be local to a medical facility, or be centralized, and data may be stored in one or more locations. Access to the smart card or to information on a computer date base may be protected from unauthorized access by passwords, biometric data, or the like.

The profiles of the permissions plan may categorize medical data being stored in an electronic health record (EHR). The EHR may consolidate medical records, including personal history, medical treatments, prescription history, results of laboratory tests and clinical investigations, hospitalization records, and the like. Not all of this information need be released to all addressees in order for the addressees to perform their appropriate function in the health care system. However, a patient is usually not a health care professional, nor is a patient fully cognizant of the legal aspects of the protections afforded to personal data, and personal medical data in particular.

The patient may elect a series of “profiles”, the profiles being a collection of medical, or medical related data, or at least and index to the data, and rules for the disclosure of such data. The rules for disclosure of the data are pre-established by the patient; and the data may be updated or augmented to reflect the latest available information. The patient may select profiles based on pervious medical history, attitude towards release of personal information, and the like. At any time, therefore, the availability of personal medical data to addressees is controlled by the profiles.

Profiles may be in the form of “opt in” or “opt out” or a combination of the two. An “opt in” profile is one in which the default selection is that the data is not disclosed, while an “opt out” profiles is one in which the default selection is that the data is disclosed.

In an aspect, the profiles may identify medical data that would be desirable for assisting in the treatment of specific syndromes, such as coronary artery disease (CAD), and recommend a service facility to the patient for generating any data that is considered medically beneficial.

A generic list of profiles may be provided to a patient initially, along with recommendations as to the addressees who may be permitted to access the data stored in the EHR and associated with the profile. The addressees may be categorized as, for example, hospitals, insurance companies, outpatient facilities (such as doctor's offices), emergency responders, and the like, and may be further defined to specify access by named entities (hospital by name, specific doctor or medical practice), or to prohibit access by named entities. Further, the list may particularize the profiles so as to associate a profile with a specific medical condition, such as cancer, coronary artery disease, hypertension, or the like, that are particular to a patient. Certain types of information may be applicable to more than one profile, such as adverse reactions to drugs, or current prescriptions.

A patient can thus control the release of data to specific addressees, or direct that a data set of the EHR be transmitted to an addressee.

In an aspect, a profile may cover provision-specific situations. For instance, if a patient has to have an operation under general anesthesia, the information as to which anesthetics the patient has received in the past, how the patient reacted to earlier anesthetics, additional risks (such as high blood pressure or dental status), and other information, may become relevant.

In another aspect, a profile may cover medication-specific applications, for instance in the context of clinical research, or to suggest to a patient taking a medication that harms the liver to release the medication information and blood chemistry test data to the treating physician.

In yet another aspect, a profile may also cover administrative tasks, such as release of patient personal information from the medical data base to insurance entities, for billing purposes, for monitoring billing data, and for expert opinion activities.

A permissions plan is an ensemble of profiles, customized by an individual. In an example, a top level profile may consolidate profiles relating to insurance, medical history data release, electronic health record release, syndrome-specific data release, prescription data release, and the like. In addition, specific profiles may be customized for medical procedures, such as a planned operation or other in-patient treatment, and the like. These may be termed sub-profiles.

The patient may initially configure a profile or sub-profile on the basis of a questionnaire, which may be filled in at a computer terminal, over the internet from a remote location, or in a paper form for patients unfamiliar with the computer technology. Suggestions, guidance and information relating to both legal aspects and the medical appropriateness of information categories for specific profiles or sub-profiles may be provided on an interactive basis to aid the patient in the decision making process.

The patient may configure different access permissions for individual physicians, physician practice groups, health care facilities, health care plans, and the like, depending on the medical situation and personal preferences of the patient.

Organizations, such as hospitals, may publish location-specific profiles, addressing local data needs, local regulations, and local best practices, and permit the patient to adopt or customize the profiles. In particular, this may be desirable for new procedures, complex procedures, or the like.

Alternatively a group of sub-profiles may be selected for presentation to the patient by a physician, or an insurance entity. Such sub-profiles may be selected on the basis of symptoms or structured information such as diagnosis, procedures, laboratory results or medications.

Additionally, profiles can be presented to a patient automatically on the basis of certain characteristics (such as age, or sex for mammography screening), diagnoses (for instance, diabetes automatically leads to the allocation of the diabetic retinopathy screening profile), membership in insurance entities, or other evaluatable properties.

When a patient has completed initial election of options of a profile, the patient may agree to the selected options and cause the data characterizing the profile to be stored in memory. This storage may be on a smart card, a central data base, or a local data base, depending on the profile type, whether the profile is of a semi-permanent or temporary basis, or the like. Temporary profiles may be useful for hospital admissions for a specific procedure, and may serve to temporarily override existing profiles or sub-profiles, without replacing them.

The patient may access the permissions plan and edit the profiles or sub-profiles as the patient's medical condition or other circumstances changes, to reflect changes in primary physician or the like. The means of accessing the data characterizing the permissions plan may depend on where the data is stored. For information stored in centralized data bases, log-on procedures, as are known in the art, may be used to ensure that access is provided only to the patient or an authorized patient representative. For information stored on a smart card, the card may be read by a computer at a facility and the patient would obtain access to the data using an analogous log-on procedure.

After interacting with the permissions plan configuration software, the modified permissions plan would be restored to the non-volatile storage media. Systems providing access to personal data may have access log and change-logging software programs and data files so that the history of access and changes to a medical data file or a permissions data file may be inspected in the case of unauthorized access thereto, or a dispute as to the contents thereof.

Permission plans may not always be suitable in certain situations such as disasters or emergency-room procedures where time is of the essence, or the patient is unable to make an informed decision relating to an emergency. In such instance, there may be a method of enabling access to data that is ordinarily restricted by the permissions plan. In such instances, the personnel involved would be specially trained and accredited for such access, and the access could be logged and monitored.

Medical information is increasingly stored and accessed in electronic form and both centralized and kept on computer memory systems. Larger and larger amounts of medical data are being accumulated for each patient, as the use of imaging modalities such as computed tomography (CT), magnetic resonance imaging (MRI), ultrasound (US) and the like are more widely used in the practice of medicine and health care. Over a period of time, the patient EHR may grow to an unwieldy size, and the selection and transmission of data from the data base to the using addressee may be slower than desired. Older medical data may be stored in slower access devices such as magnetic tape, rotating disk storage, and the like. The transmission bandwidth of any telecommunications network is limited, for technical and economic reasons, and the review of the entire corpus of medical data in the EHR may be time consuming. It may also be impractical as being an overwhelming task, in view of the time constraints of the medical profession.

The permissions plan, particularly the profiles and sub-profiles may serve to focus the data retrieval efforts, as not all of the EHR data would be accessible to a specific addressee. Moreover, the profile may be directed to a particular illness, hospital admission, or the like, and have been customized so as to substantially reduce the size of the data set that may be accessed in the specific situation. Providing that the profiles are appropriately designed and focused, the relevant information will be selected for access by the addressee, both reducing the data transmission costs and increasing the speed with the applicable data can be comprehended by a human.

In another aspect, the profiles may be used in conjunction with a computer assisted diagnosis method. The patient may answer a series of questions related to perceived symptoms and experiences, and profiles of relevance may be presented to the patient for confirmation or acceptance so that appropriate data may be extracted from the EHR for access by a medical professional.

In a further aspect, a physician may order a test or study of a patient for diagnostic purposes. As the data is being entered in the EHR, the type of data being entered may be checked against the existing permissions plan to determine if the data access protocol has already been established. If the protocol has not been established, the patient may be presented with a selection of recommended suitable choices.

Another use of the system would be to provide an overview of the profiles. That is, a hospital or physician or a hospital may be able to access the profile itself, but not the data protected by the permission plan. This may assist a health care provider in determining that relevant data may exist, and to initiate a request to the patient for access to the data, or to suggest to the patient that such data be obtained. The patient may then be able to discuss the relevance of the data to the present circumstances, and make an informed decision as to whether the data should be released.

In support of such requests of patients, a probabilistic association of specific data types with possible diagnoses may be made based on a generally accepted diagnosis or treatment plan published by a hospital, medical society, or the like. This would enable data taken for one diagnostic purpose to be suggested to the patient as being useful for another diagnostic purpose, which may be relevant at the present time. Due to the complexity of medical practice, the same type of diagnostic data may be used for various purposes, and while the patient may not wish to make the data generally available, the release of the data in certain circumstances may be warranted and beneficial. However, without the prompting of an association, the patient may not be knowledgeable enough to identify the need.

Moreover, it is not uncommon for multiple versions of the same or similar test to be performed on a patient when more than one provider is involved, as the fact that a test has been performed may be known only by the patient, and the patient may not understand the purpose of the test that was performed, or the significance of the test results. Examination and test requests may be checked against the EHR so that potentially relevant existing data may be identified, and the patient given the opportunity to release the data so that a duplication of testing is avoided.

Where the release of data to an institution is involved, the profiles may be combined with description of quantitative and functional roles of addressees. Qualitative roles may describe properties of a user such as orthopedics, surgeon working at hospital XYZ, attending physician, and the like, and function roles may describe the treatment relationship. That is, surgeons at a hospital treating a patient for a specific syndrome such as coronary artery disease may be considered to be in a functional relationship with the patient. The persons may be identifiable by the codes or biometric data being used to control information access or system log-on, and the status of the person may then be used to determine the applicability of the release provisions of the permissions plan with respect to the individual.

When a patient reviews or modifies a permissions plan, such as may occur before admission to a hospital for elective surgery, or treatment for a specific disease, such a diabetes, the patient may elect the persons having a qualitative and functional relationship, including designation of specific individuals having permission to access the data already existing in the EHR or that will be added to the EHR during the hospital admittance.

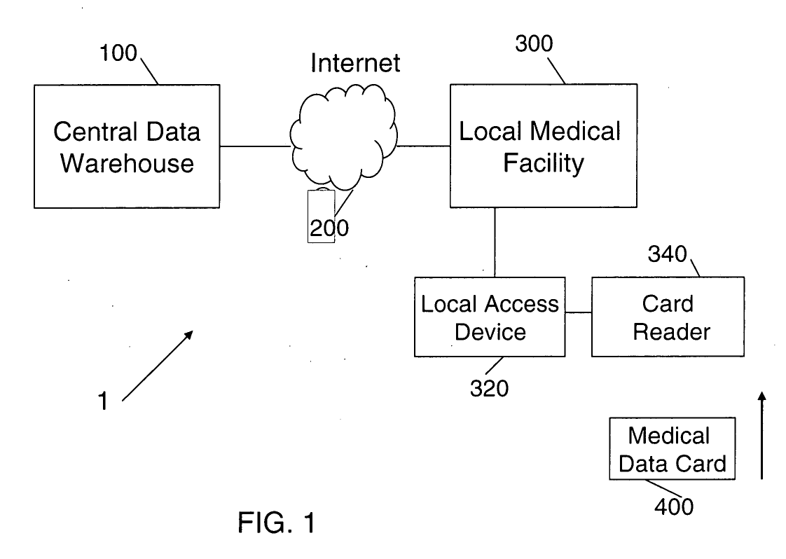

An example of a system configuration 1 which may be suitable for a national or regional health care system is shown in FIG. 1. A central data warehouse 100 may be located remotely from any medical facility, or co-located with such a facility. As the central data warehouse 100 may be connected with the other elements of the system 1 over a telecommunications network, which may be the Internet 200, the physical relationship of the system components is not usually of significance. Service to a patient is provided by a local medical facility 300, connected to the central data warehouse 100 by the Internet 200. There may be a plurality of local medical facilities, at various locations, and the functions of each local medical facility may differ. For example, the local medical facility may be a hospital, a physician's office, an insurance provider, or an emergency medical vehicle.

Access to medical data comprising the patient's EHR may be through a local access interface 320 at the local medical facility 300. The identification of the individual patient and of the health care providers may be by the use of “smart cards”, which may be medical data cards 400 that may be read by a card reader 340, interfaced to the local access interface 320. The local access interface 320 may be a keyboard and display through which identification numbers and passwords are entered, or biometric data scanned, or the like.

The data in the individual patient EHR may be stored in the central data warehouse 100, or one or more local medical facility data bases. At the central data warehouse 100, a data base management system is provided with a server computer 140 connected to the Internet or other telecommunications network. Data accessed by the server 140 may be stored on a variety of memory systems, both local to the central data warehouse 100, or at other facilities such as one or more medical facilities 300. An aspect of the data base management system may include metadata identifying the data files at the various facilities so that they may be accessed or retrieved. In another aspect, the permissions plan may be stored on the data base at the central data warehouse 100, and may also have portions stored at a local medical facility 300, where the permissions plan addresses only local or temporary access.

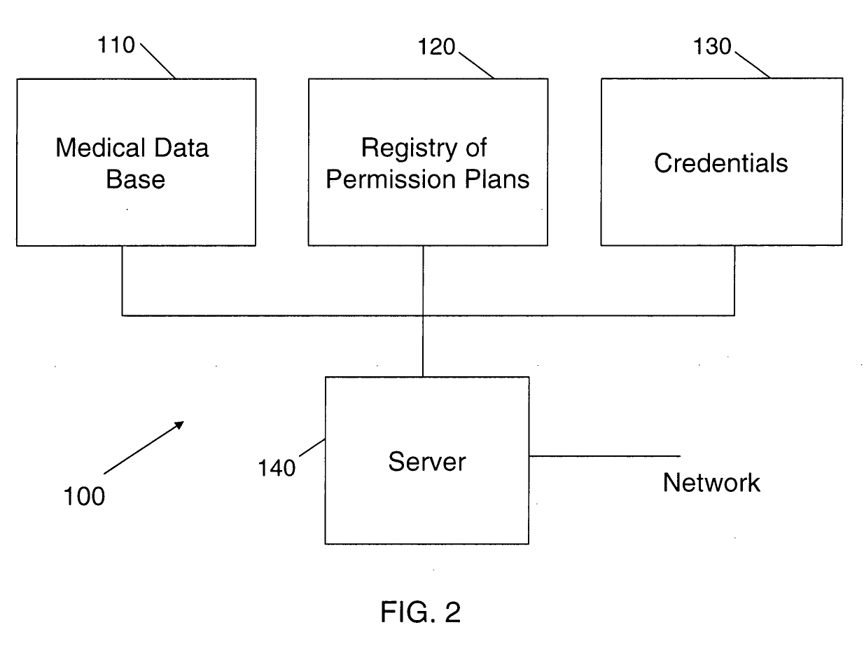

FIG. 2 shows an example of a central data warehouse 100. A server 140, executing instructions provided by a computer program product, which may be stored on a machine readable medium, may be configured to execute a data base management function, that includes: maintaining one or more data bases, which may include a medical data base 110, permission plans 120, and, medical credentials 130. The data bases may be local to the central data warehouse 100, or include access to remotely located data bases such as may be found at medical facilities 300. The medical data base 110 may be a portion of a patient's EHR, with other portions of the EHR stored at other medical facilities. The permissions plan data 120 may control the release of data in the medical data base 110, including aspects of the data at the local medical facilities. The credentials 130 of users of the medical data base 110 are compared against the permissions plan 120 in order to determine the types of data which may be released to an addressee (user), and any masking or other redacting of the data being released.

The data base management system software, executing on the server 140, maintains the medical data base 110, which may include metadata linking to other data bases, the permissions plans 120 and the credentials 130. The server 140 communicates with the remainder of the health care system over a network, which may be the Internet or other telecommunications network.

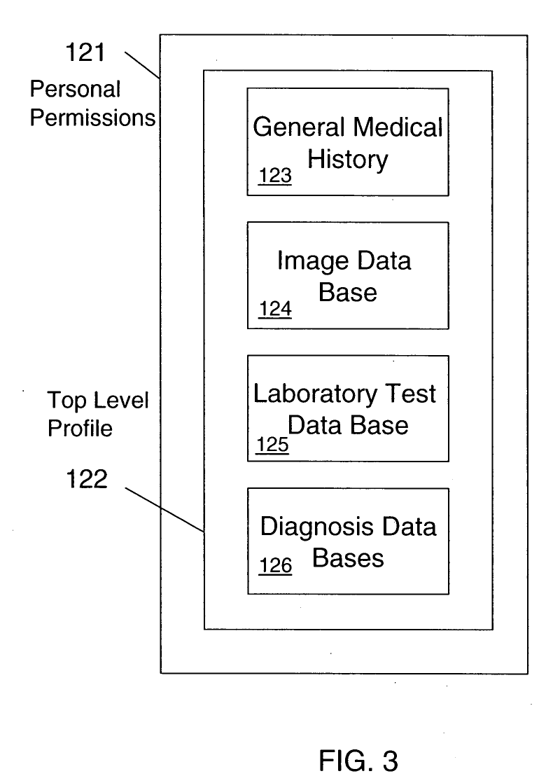

In an aspect, the permissions plan 120, shown in FIG. 3 may include a top level plan 121, which may contain personal information of the patient such as identification number, residence address, demographic information and the like, subject to a first profile controlling the release thereof. Within the permissions plan, there may be a top level profile 122 which references a plurality of profiles associated with specific types of medical data. For example, categories of data may include a general medical history 123, an image data base 124, a laboratory test results data base 125, and a diagnosis data base 126, as examples. Within these data bases, the data may be further categorized. In the image data base, the data may be characterized by the type of imaging modality used to obtain the data, the portion of the body imaged, and the report on each study. The diagnosis data base may include a record of each individual diagnosis, a clustering of diagnoses by medical specialty, and the like. Profiles in the permissions plan may restrict or permit the retrieval of data by persons having various credentials.

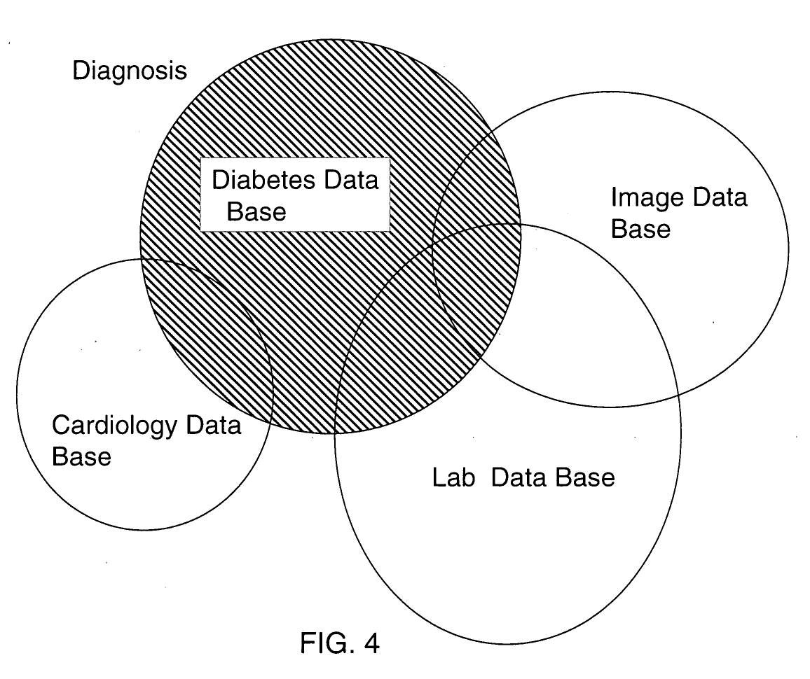

Profiles may extend across the boundaries of the specific data bases. For example, FIG. 4 illustrates conceptually a profile that may have been suggested to, and agreed to, by a patient having a diagnosis of Type II diabetes. This may permit addressees having specific credentials to access portions of the image data base, the laboratory test data base, and the cardiology diagnosis aspect of the diagnosis data base. The profile proposed to the patient may be based on a diagnostic or treatment plan promulgated by a medical society, the medical facility, or other authority. In this example, the scope of the data released has been focused with respect to the syndrome, and data not considered medically relevant is protected from more general access. The profile may select the data to be disclosed on an algorithmic basis, and may use probabilistic associations which also may include intermediary data analysis to assess the relevance.

The addressee requesting the data, which may be an organization such as an insurance provider, a specific physician or technician by name, or a person having a functional relationship to an admitted patient, as examples, may enter a form of identification into the system, for example such as by the smart card 400 as shown in FIG. 1. The patient may also have been identified in a similar manner. In a hospital, the admitted patient may be provided with a machine readable wrist strap or other passive means of identification, which may be scanned by a bar code reader, or may be a radio-frequency identification (RFID) device. The addressees may be similarly identified, so that an addressee in the vicinity of the patient may have credentials automatically entered. Depending on privacy concerns, further identification may be necessary to view the retrieved records. That is, when an addressee is in proximity to the patient, data may be retrieved from the data base automatically in accordance with the permissions plan, but the display of the data may require the addressee to perform another step so as to validate the addressee identity.

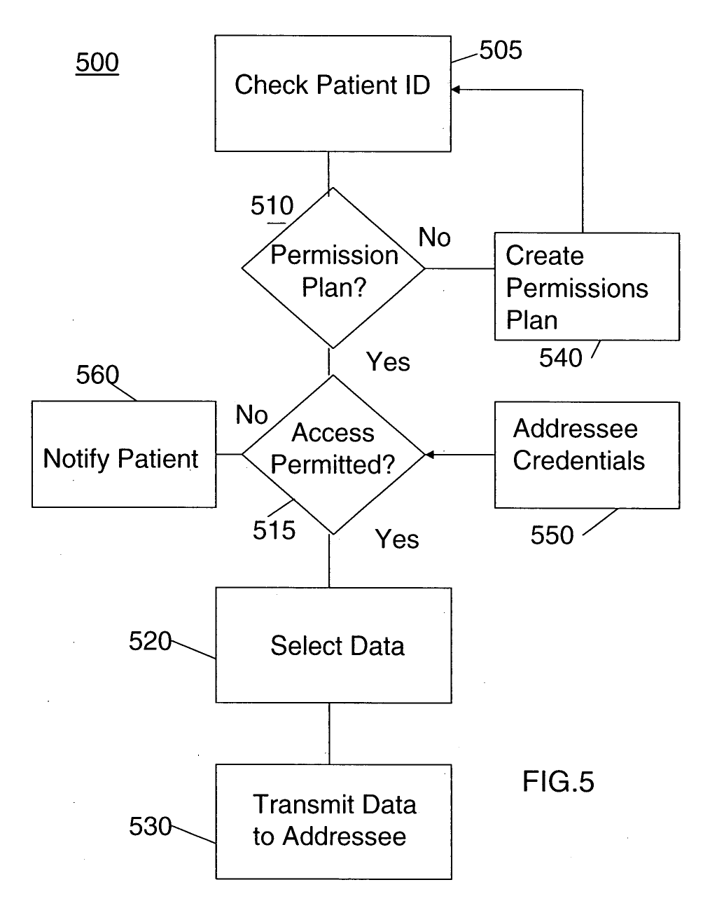

A method 500 of managing the release of data from an individual patient EHR, as shown in FIG. 5, includes checking or reading or entering the patient identification, which may be an identification number (step 505), and determining if the patient has an existing permission plan (step 510). If the patient does not have an existing permission plan, or the permission plan is either out of date or inappropriate for the potential course of treatment, a proposed permission plan (step 540) is created, allowing the patient to exercise control over the release of information from the personal EHR (step 540). Where a permissions plan exists, the permissions plan may be used to determine if a specific addressee may be provided access to data in the EHR (step 515). The addressee enters credentials (step 550) and a determination is made as to whether the requested data is releasable to the addressee in accordance with the permissions plan (step 515). If an attempt to access data is unauthorized, the patient may be notified (step 560). In addition, if the permissions plan is overridden, as may happen in an emergency situation, a log file detailing the access to the EHR is created, so that an audit of the access may be performed.

Where an addressee is authorized to access a set of data from the EHR, the data at the central data warehouse 100, and at local medical facilities 300 may be searched using a data base search engine, as is known in the art, and data meeting the release criteria selected (step 520). The data may then be transmitted to the addressee (step 530). However, in some examples, only a portion of the releasable data is transmitted, with the remainder represented by metadata. The metadata, may be used by the addressee to determine such further data as may be necessary in the present circumstances without the need to download all of the actual data which, in the case of image data, may occupy a significant bandwidth.

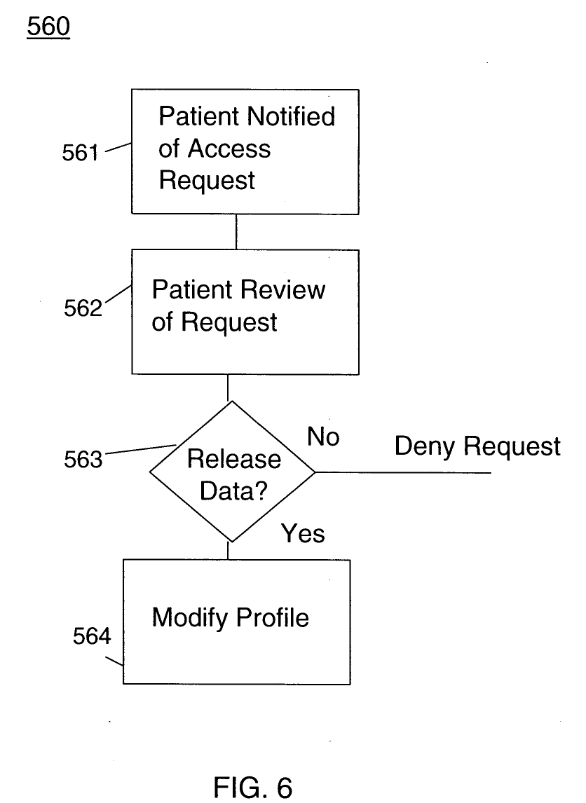

In an aspect, shown in FIG. 6, when a request is made for data from the EHR for which a patient permission plan does not exist with respect to an addressee, the notification of the patient step may include providing notification to the patient 561, and permitting the patient to review the request 562. Such data requests may be legitimate and in the patient's interest as a medical condition changes or becomes expressed, and the patient may be provided with various recommendations as to the appropriate data to release. If the patient decides to release some or all of the requested data to the addressee (step 563), the patient may cause the permissions plan to be modified, such that a profile of the permissions plan may permit the release of some or all of the requested data (step 564). If the patient denies the request, the data base management system is notified and the request denied. Where the profile has been modified, either permanently or temporarily, the data indicated to be releasable to the addressee is processed and released.

Where a request for data is made by an addressee, the request may be for example, for a generic data type, or specific data within the generic type, or a diagnosis-based selection of data from a variety of generic data types.

The review of a permissions plan or a profile or sub-profile of a permissions plan by a patient (step 562) may include reviewing the of information being requested by the addressee, the addressee credentials, and information provided by the health care system that may assist the patient in making an informed decision as to the relevance of the request (step 562b). The patient may evaluate the request, along with the information provided, which may include statistical information indicating the probability of the information being useful in the present situation (step 562c). The patient may consider the information provided, the identity of the addressee, and other factors, and decide whether to release the data (step 562d). Using information provided, the patient then may make an informed modification of the profile in the permissions plan (step 564, as previously described).

Medical data systems may be used collect information on patients, including medical history, demographic information, results of medical tests, prior treatment, including specific worksteps and outcomes, and other information related to individual patients. The course of treatment, or care path for a patient, may be based an electronic formula or other algorithm, with the detailed course of treatment based on the symptoms, tests and patient response to treatment.

The care plan may be administered via a number of medical facilities and/or medical personnel, such as specialists, located at dispersed locations, each requiring access to at least a portion of the patient EHR. After a workstep within the care plan is administered at one medical facility, the care plan may be updated, and the EHR modified accordingly. For instance, data regarding the status of and/or details regarding the results of the workstep performed, as well as other patient information may be entered by medical personal located at that medical facility via a user interface.

The data entered may be used to update, via a processor, a data base of the individual patient EHR stored in either a local or a remote database accessible over a telecommunications network. Other medical facilities that perform subsequent worksteps within the care plan may then remotely access and locally display the updated data base of the EHR to ascertain the current status of the patient/care plan, before performing the next or other subsequent workstep within the care plan.

The system and method may include a computer program product, stored or loaded onto the computer, the instructions of the program configuring the computer to manage the release of patient data in an EHR in accordance with a permissions plan. The system may include a user interface that implements access rights or other security measures. The user interface may provide user management at one facility with access to data associated with the EHR data collected at other facilities.

While embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

What is claimed is:

1. A system for controlling the release of medical-related information, the system comprising:
a central data warehouse, including at least a data base of personal permissions plans;
an interface to a telecommunications network;
wherein a request is received through the interface and credentials of an addressee compared against one of the personal permissions plans, and data authorized by the personal permissions plan is transmitted though the interface to the addressee.

2. The system of claim 1, wherein the central data warehouse maintains a data base of personal medical records comprising at least a portion of a personal electronic health record (EHR) for a person and a data base of personal permission plans, each personal permission plan controlling the release of information from the personal EHR.

3. The system of claim 1, further comprising:
a local access device, located at a medical facility, that communicates with the central data warehouse by transmitting data over a telecommunications network;
wherein the local access device is configured to accept credential data.

4. The system of claim 3, wherein the credential data is input to the local access device through a smart card reader.

5. The system of claim 4, wherein the smart card reader accepts information from one of a radio frequency identification device (RFID), a magnetic card, or a bar code reader.

6. The system of claim 3, wherein the local access device has a visual display to display the information transmitted from the central data warehouse.

7. A method of managing the release of medical data from an electronic health record (EHR), the method comprising:
maintaining a personal electronic health record (EHR) at least in part, in a central data warehouse;
maintaining at least a copy of a personal permissions plan corresponding to each EHR;
receiving requests for data in the EHR, the requests including the credentials of the addressee requesting the data;
comparing the credentials of the addressee with the personal permissions plan and determining whether the requested data is releasable to the addressee;
transmitting at least metadata representing the releasable data.

8. The method of claim 7, wherein when requested data is not releasable to the addressee, the patient is notified of the request.

9. The method of claim 8, wherein the patient is presented with options for managing the requests, including confirming the refusal of the request, or modifying the permissions plan so as to permit the request.

10. The method of claim 9, wherein a permissions plan includes a plurality of profiles, the profiles controlling the release of portions of the EHR.

11. The method of claim 10, wherein at least one profile has an associated data file containing information usable by the patient in evaluating the request for release of the data.

12. The method of claim 11, wherein the information includes statistical estimates of the relevance of the requested data to one of the potential medical diagnosis, or the known syndrome.

13. The method of claim 7, wherein the personal permission plan may be pre-empted by an addressee having special credentials.

14. The method of claim 13, wherein when the personal permission plan has been preempted, an access log is created including details of the credentials of the addressee having access, and the details of the data accessed or changed in the EHR.

15. A computer program product, the product being embodied in a computer readable media and having instructions configuring a computer to perform a method of managing the release of medical data from an electronic health record (EHR), the method comprising:
maintaining a personal electronic health record (EHR) at least in part, in a central data warehouse;
maintaining at least a copy of a personal permissions plan corresponding to each EHR;
receiving requests for data in the EHR, the requests including the credentials of the addressee requesting the data;
comparing the credentials of the addressee with the personal permissions plan and determining whether the requested data is releasable to the addressee;
transmitting at least metadata representing the releasable data.
